(19) United States
(12) Patent Application Publication
(10) Pub. No.: US 2013/0080731 A1
(43) Pub. Date: Mar. 28, 2013

(54) METHOD AND APPARATUS FOR PERFORMING MEMORY MANAGEMENT

(71) Applicant: Ping-Yi Hsu, Kaohsiung City (TW)

(72) Inventor: Ping-Yi Hsu, Kaohsiung City (TW)

(21) Appl. No.: 13/369,313

(22) Filed: Feb. 9, 2012

Related U.S. Application Data
(60) Provisional application No. 61/540,363, filed on Sep. 28, 2011.

(51) Int. Cl. G06F 12/10

(52) U.S. Cl. 711/206; 711/E12.061

(57) ABSTRACT

A method for performing display control is provided, where the method is applied to an electronic device. The method includes: managing a plurality of physical blocks of at least one non-volatile (NV) memory according to a block address translation rule, the block address translation rule of both of one-to-multiple block address translation and multiple-to-one block address translation; and when it is detected that erasing a specific logical block represented by a specific block logical address is required, determining a set of block physical addresses corresponding to the specific block logical address according to the block address translation rule and erasing a set of physical blocks represented by the set of block physical addresses within the plurality of physical blocks. An associated apparatus is also provided.

### CROSS REFERENCE TO RELATED APPLICATIONS

This application claims the benefit of U.S. provisional application No. 61/540,363, which was filed on Sep. 28, 2011 and is entitled “APPARATUS AND METHOD FOR MEMORY MANAGEMENT”, and is incorporated herein by reference.

### BACKGROUND

The present invention relates to access control of a NOR Flash memory, and more particularly, to a method for performing memory management, and to an associated apparatus.

Typically, options of the minimum size of a physical block of a specific type of Flash memories are limited. For example, specifications provided by some Flash memory manufacturers of NOR Flash memories may indicate that the minimum size of a physical block can be either 4 kilobytes (KBs) or 64 KBs. In a situation where hardware resources for controlling a NOR Flash memory are limited, some problems may occur. More particularly, managing the NOR Flash memory in units of 4 KBs may cause the overall storage volume of a memory device/module implemented with the NOR Flash memory to be too small, while managing the NOR Flash memory in units of 64 KBs may cause a reserved space of the NOR Flash memory to be oversized. Thus, a novel method is required for enhancing access control of a non-volatile (NV) memory.

### SUMMARY

It is therefore an objective of the claimed invention to provide a method for performing memory management, and to provide an associated apparatus, in order to solve the above-mentioned problems.

An exemplary embodiment of a method for performing memory management comprises: managing a plurality of physical blocks of at least one non-volatile (NV) memory according to a block address translation rule, the block address translation rule of both of one-to-multiple block address translation and multiple-to-one block address translation; and when it is detected that erasing a specific logical block represented by a specific block logical address is required, determining a set of block physical addresses corresponding to the specific block logical address according to the block address translation rule and erasing a set of physical blocks represented by the set of block physical addresses within the plurality of physical blocks. In particular, the NV memory is utilized for storing program codes to be executed by a portable electronic device, and the method further comprises: when it is detected that reading a portion of a physical block of the NV memory is required, reading the portion of the physical block byte by byte.

An exemplary embodiment of an apparatus for performing memory management is provided, wherein the apparatus comprises at least one portion of an electronic device. The apparatus comprises a processing circuit arranged to control operations of the electronic device, wherein the processing circuit comprises a management module and a control module. The management module is arranged to manage a plurality of physical blocks of at least one non-volatile (NV) memory according to a block address translation rule, the block address translation rule of both of one-to-multiple block address translation and multiple-to-one block address translation. In addition, the control module is arranged to control access to the NV memory, wherein when it is detected that erasing a specific logical block represented by a specific block logical address is required, the control module determines a set of block physical addresses corresponding to the specific block logical address according to the block address translation rule and erases a set of physical blocks represented by the set of block physical addresses within the plurality of physical blocks. In particular, the electronic device is a portable electronic device, and the NV memory is utilized for storing program codes to be executed by the portable electronic device, wherein the NV memory is embedded in the portable electronic device. When it is detected that reading a portion of a physical block of the NV memory is required, the control module reads the portion of the physical block byte by byte.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing memory management according to a first embodiment of the present invention.

FIG. 2 illustrates a flowchart of a method for performing memory management according to an embodiment of the present invention.

FIG. 3 illustrates an exemplary block address translation scheme involved with the method shown in FIG. 2 according to an embodiment of the present invention.

FIG. 4 illustrates an exemplary block address translation scheme involved with the method shown in FIG. 2 according to a variation of the embodiment shown in FIG. 3.

FIG. 5 illustrates an exemplary block address translation scheme involved with the method shown in FIG. 2 according to another variation of the embodiment shown in FIG. 3.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

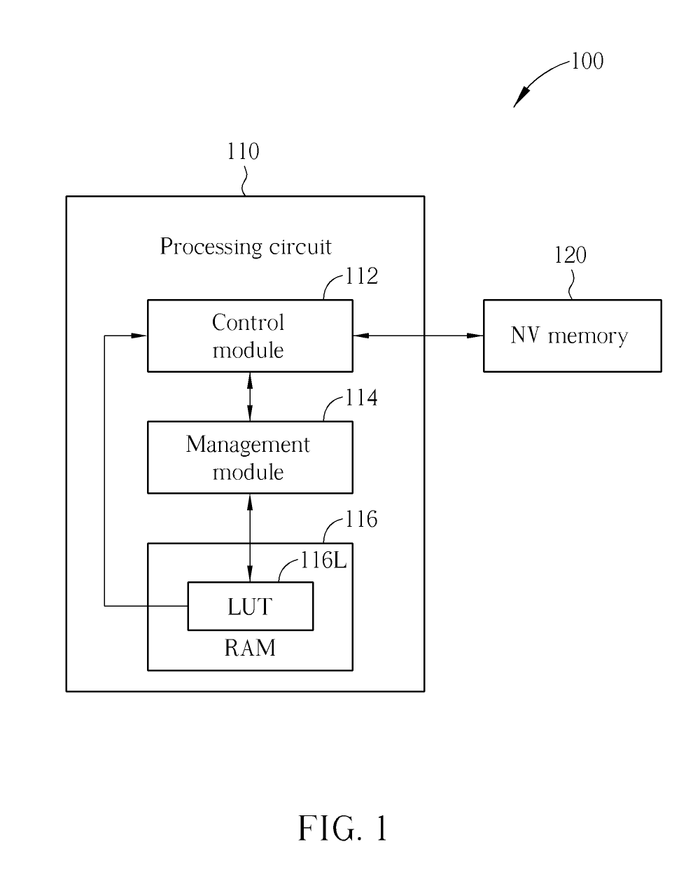

Please refer to FIG. 1, which illustrates a diagram of an apparatus 100 for performing memory management according to a first embodiment of the present invention. According to different embodiments, such as the first embodiment and some variations thereof, the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. In another example, the apparatus 100 can be an audio/video system comprising the electronic device mentioned above. Examples of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

As shown in FIG. 1, the apparatus 100 comprises a processing circuit 110 and at least one non-volatile (NV) memory 120, where the processing circuit 110 comprises a control module 112, a management module 114, and a memory such as a random access memory (RAM) 116. The processing circuit 110 is arranged to control operations of the electronic device, and the NV memory 120 is arranged to store information that can be accessed by the processing circuit 110. More particularly, the management module 114 is arranged to manage a plurality of physical blocks of the aforementioned at least one NV memory 120 according to a block address translation rule, the block address translation rule of both of one-to-multiple block address translation and multiple-to-one block address translation. In addition, the control module 112 is arranged to control access to the NV memory 120 according to the block address translation rule, and more particularly, according to some block address translation information associated to the block address translation rule mentioned above. In practice, the aforementioned at least one NV memory 120 may comprise at least one NOR Flash memory. More particularly, the NV memory 120 can be the NOR Flash memory.

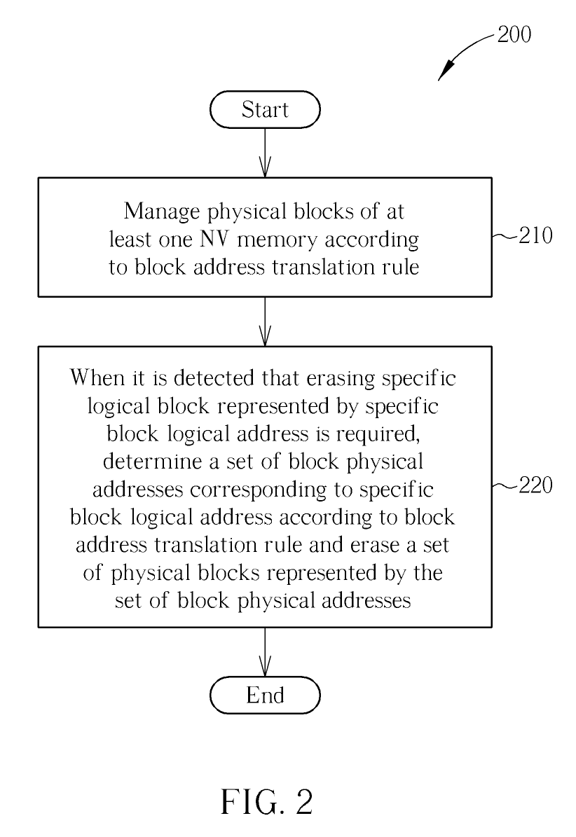

FIG. 2 illustrates a flowchart of a method 200 for performing memory management according to an embodiment of the present invention. The method shown in FIG. 2 can be applied to the apparatus 100 shown in FIG. 1. The method is described as follows.

In Step 210, the processing circuit 110 (more particularly, the management module 114) manages the plurality of physical blocks of the aforementioned at least one NV memory 120 according to a block address translation rule such as that mentioned above (i.e. the block address translation rule of both of one-to-multiple block address translation and multiple-to-one block address translation). For example, under control of the management module 114, the aforementioned block address translation information associated to the block address translation rule can be implemented as at least one look-up table (LUT) 116L temporarily stored in the RAM 116, and a backup version of the block address translation information can be stored in a storage unit/module (e.g. a NV memory such as the NV memory 120, or a storage device that differs from the NV memory 120) within the apparatus 100.

In Step 220, when it is detected that erasing a specific logical block represented by a specific block logical address is required, the processing circuit 110 (more particularly, the control module 112) determines a set of block physical addresses corresponding to the specific block logical address according to the block address translation rule and erases a set of physical blocks represented by the set of block physical addresses within the plurality of physical blocks. Typically, the size of the specific logical block is a multiple of that of the set of physical blocks. More particularly, the ratio of the size of each logical block of the NV memory 120 to that of a corresponding set of physical blocks of the NV memory 120 is equal to a predetermined positive integer. For example, in a situation where the predetermined positive integer is equal to two, the size of each logical block of the NV memory 120 is twice the size of any physical block within the corresponding set of physical blocks. In another example, in a situation where the predetermined positive integer is equal to three, the size of each logical block of the NV memory 120 is triple the size of any physical block within the corresponding set of physical blocks.

According to this embodiment, the management module 114 can store/update at least one LUT such as the aforementioned at least one LUT 116L according to the block address translation rule to manage the plurality of physical blocks, and the control module 112 can determine the set of block physical addresses mentioned in Step 220 according to the LUT 116L. Typically, within the LUT 116L, the number of block physical addresses corresponding to a first block logical address is equal to that of block physical addresses corresponding to a second block logical address. For example, the number of block physical addresses corresponding to the block logical address L_Add_1 is equal to the number of block physical addresses corresponding to the block logical address L_Add_2, where the block logical addresses L_Add_1 and L_Add_2 are different from each other. More particularly, within the LUT 116L, the number of block physical addresses corresponding to each block logical address is equal to a predetermined number. For example, in a situation where the predetermined number is equal to two, the number of block physical addresses corresponding to the block logical address L_Add_1 is equal to two, and the number of block physical addresses corresponding to the block logical address L_Add_2 is equal to two. In another example, in a situation where the predetermined number is equal to three, the number of block physical addresses corresponding to the block logical address L_Add_1 is equal to three, and the number of block physical addresses corresponding to the block logical address L_Add_2 is equal to three.

In addition, the electronic device mentioned above can be a portable electronic device, and the NV memory 120 can be utilized for storing program codes to be executed by the portable electronic device (more particularly, the processing circuit 110). For example, the NV memory 120 can be embedded in the portable electronic device, and can be positioned outside the processing circuit 110. This is for illustrative purposes only, and is not meant to be a limitation of the present invention. According to a variation of this embodiment, the NV memory 120 can be embedded in the processing circuit 110. According to another variation of this embodiment, the NV memory 120 can be positioned in an external device outside the portable electronic device.

No matter whether the NV memory 120 is positioned within the portable electronic device or outside the portable electronic device, and no matter whether the NV memory 120 is positioned within the processing circuit 110 or outside the processing circuit 110, the operations of the method 200 shown in FIG. 2 and associated operations will not be hindered. For example, when it is detected that reading a portion of a physical block of the NV memory 120 is required, the control module 112 can read the portion of the physical block byte by byte.

In some embodiments, such as some variations of the embodiment shown in FIG. 2, at least one portion (e.g. a portion or all) of the operations of Step 210 and Step 220 can be repeated. In some embodiments, such as some variations of the embodiment shown in FIG. 2, at least one portion (e.g. a portion or all) of the operations of Step 210 and Step 220 can be performed at the same time.

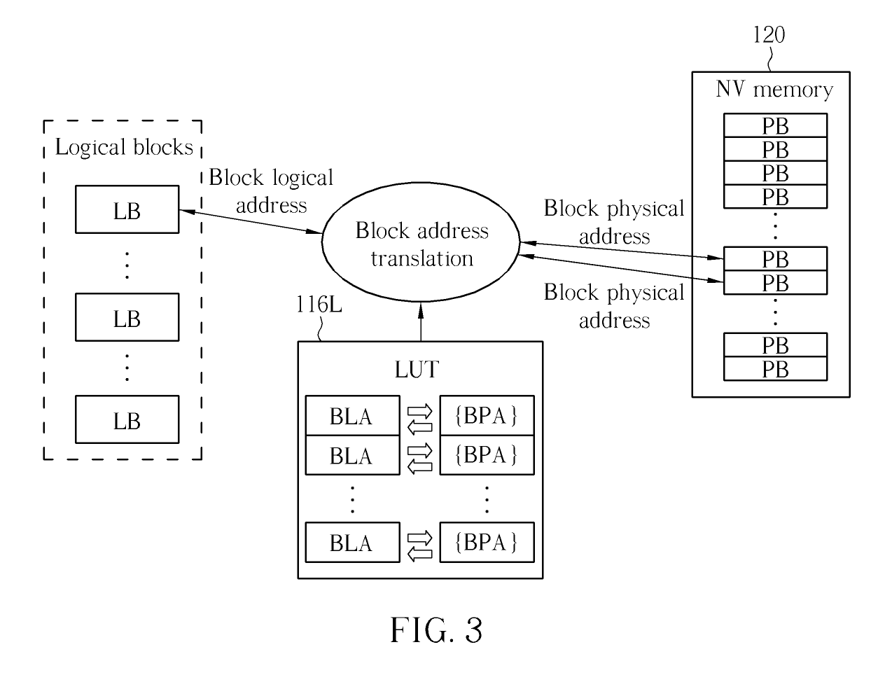

FIG. 3 illustrates an exemplary block address translation scheme involved with the method 200 shown in FIG. 2 according to an embodiment of the present invention. Some exemplary logical blocks (each of which is labeled “LB” in FIG. 3) are illustrated to have a larger size than that of some exemplary sets of physical blocks (each of which is labeled “PB” in FIG. 3) corresponding to these logical blocks, respectively. For example, the size of any of the logical blocks shown in FIG. 3 can be twice the size of any of the physical blocks shown in FIG. 3. This is for illustrative purposes only, and is not meant to be a limitation of the present invention. According to a variation of this embodiment, the size of any of the logical blocks under consideration can be another multiple of the size of any of the physical blocks under consideration. According to another variation of this embodiment, the size of any of the logical blocks of a first logical block group can be a first multiple of the size of any of the physical blocks associated to the first logical block group, and the size of any of the logical blocks of a second logical block group can be a second multiple of the size of any of the physical blocks associated to the second logical block group. According to some variations of this embodiment, the size of any of the logical blocks under consideration can be greater than the size of any of the physical blocks under consideration, where it is unnecessary that the size of any of the logical blocks under consideration is exactly a multiple of the size of any of the physical blocks under consideration in these variations, i.e., the ratio of the size of a logical block to that of a physical block can be a positive real number in these variations.

In the embodiment shown in FIG. 3, the LUT 116L indicates bi-directional mapping relationships between the block logical addresses (such as a plurality of block logical addresses, each of which is labeled “BLA” in FIG. 3) and the corresponding sets of block physical addresses (such as a plurality of sets of block physical addresses, each set of which is labeled “{BPA}” in FIG. 3), where the contents of the LUT 116L may be updated when needed. For example, a set of physical blocks, which may include two physical blocks in this embodiment, may correspond to a logical block. Based on the LUT 116L disclosed above, the block address translation operation performed by the processing circuit 110 may map the block logical address representing the logical block under consideration to the two block physical addresses respectively representing the two physical blocks corresponding to this logical block, or map the two block physical addresses respectively representing the two physical blocks to the block logical address representing the logical block under consideration.

As the block address translation scheme disclosed in FIG. 3 can be implemented as a bottom layer of the access control of the NV memory 120, each logical block is substantially implemented by utilizing multiple physical blocks (more particularly, two physical blocks in this embodiment). Similar descriptions are not repeated in detail for this embodiment.

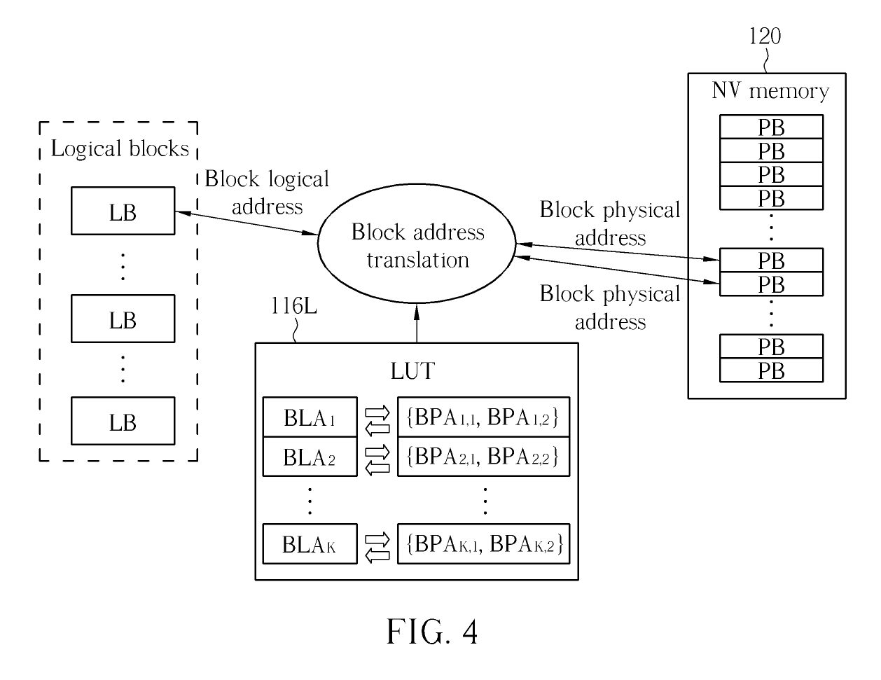

FIG. 4 illustrates an exemplary block address translation scheme involved with the method 200 shown in FIG. 2 according to a variation of the embodiment shown in FIG. 3. Here, some exemplary block logical addresses BLA₁, BLA₂, . . . , and BLA_{K}, with the notation K representing a positive integer, are taken as examples of the block logical addresses respectively labeled “BLA” in FIG. 3, and some exemplary sets of block physical addresses {BPA_{1,1}, BPA_{1,2}}, {BPA_{2,1}, BPA_{2,2}}, . . . , and {BPA_{K,1}, BPA_{K,2}} are taken as examples of the corresponding sets of block physical addresses respectively labeled “{BPA}” in FIG. 3.

Based on the LUT 116L disclosed above, the block address translation operation performed by the processing circuit 110 may map the block logical address representing the logical block under consideration (e.g. a block logical address BLAₖ, with the notation k representing an integer falling within the range of the interval [1, K]) to the two block physical addresses respectively representing the two physical blocks corresponding to this logical block (e.g. a set of block physical addresses {BPA_{k,1}, BPA_{k,2}}), or map the two block physical addresses respectively representing the two physical blocks (e.g. the set of block physical addresses {BPA_{k,1}, BPA_{k,2}}) to the block logical address representing the logical block under consideration (e.g. the block logical address BLAₖ). Similar descriptions are not repeated in detail for this embodiment.

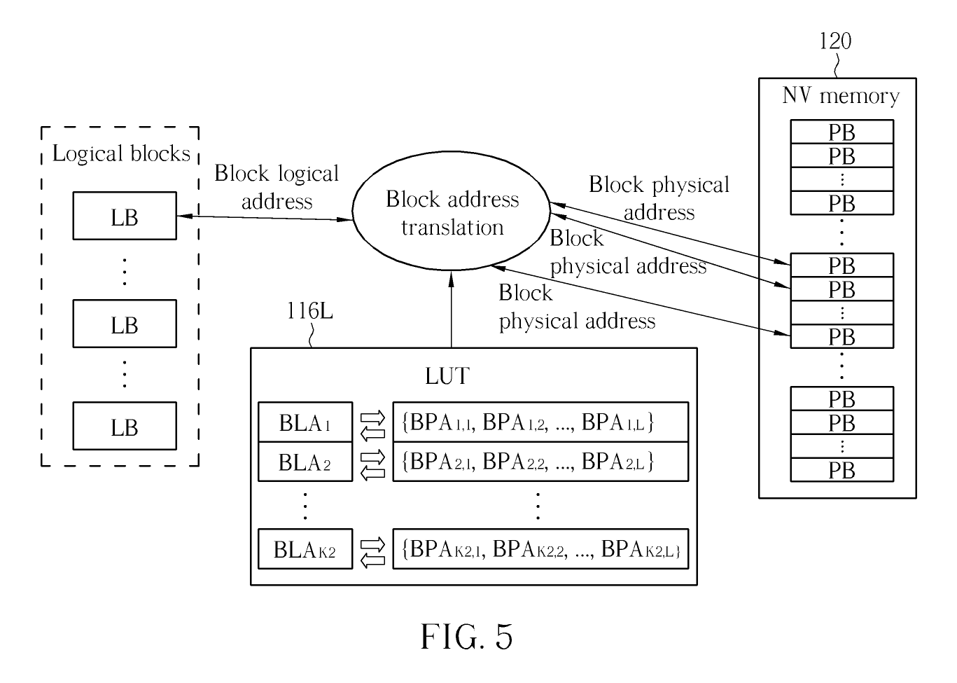

FIG. 5 illustrates an exemplary block address translation scheme involved with the method 200 shown in FIG. 2 according to another variation of the embodiment shown in FIG. 3. Here, some exemplary block logical addresses BLA_{1,1}, BLA₂, . . . , and BLA_{K2}, with the notation K2 representing a positive integer, are taken as examples of the block logical addresses respectively labeled “BLA” in FIG. 3, and some exemplary sets of block physical addresses {BPA_{1,1}, BPA_{1,2}, . . . , BPA_{1,L}}, {BPA_{2,1}, BPA_{2,2}, . . . , BPA_{2,L}}, . . . , and {BPA_{K2,1}, BPA_{K2,2}, . . . , BPA_{K2,L}}, with the notation L representing a positive integer, are taken as examples of the corresponding sets of block physical addresses respectively labeled “{BPA}” in FIG. 3.

In the embodiment shown in FIG. 5, the LUT 116L indicates bi-directional mapping relationships between the block logical addresses (such as the block logical addresses BLA_{1,1}, BLA₂, . . . , and BLA_{K2} shown in FIG. 5) and the corresponding sets of block physical addresses (such as the sets of block physical addresses {BPA_{1,1}, BPA_{1,2}, . . . , BPA_{1,L}}, {BPA_{2,1}, BPA_{2,2}, . . . , BPA_{2,L}}, . . . , and {BPA_{K2,1}, BPA_{K2,2}, . . . , BPA_{K2,L}} shown in FIG. 5), where the contents of the LUT 116L may be updated when needed. For example, a set of physical blocks, which may include L physical blocks in this embodiment, may correspond to a logical block. Based on the LUT 116L disclosed above, the block address translation operation performed by the processing circuit 110 may map the block logical address representing the logical block under consideration (e.g. a block logical address BLAₖ₂, with the notation k2 representing an integer falling within the range of the interval [1, K2]) to the L block physical addresses respectively representing the L physical blocks corresponding to this logical block (e.g. a set of block physical addresses {BPA_{k2,1}, BPA_{k2,2}, . . . , BPA_{k2,L}}), or map the L block physical addresses respectively representing the L physical blocks (e.g. the set of block physical addresses {BPA_{k2,1}, BPA_{k2,2}, . . . , BPA_{k2,L}}) to the block logical address representing the logical block under consideration (e.g. the block logical address BLAₖ₂). Similar descriptions are not repeated in detail for this embodiment.

It is an advantage of the present invention that the present invention method and apparatus provide block address translation architecture/schemes, such as that of any of the embodiments/variations disclosed above, to enhance NV memory access control. For example, in a situation where hardware resources for controlling a NOR Flash memory are limited while specifications of the NOR Flash memory indicates that the minimum size of a physical block can be either 4 kilobytes (KBs) or 64 KBs, managing the NOR Flash memory in units of a predetermined multiple of 4 KBs (e.g. 8 KBs, 12 KBs, 16 KBs, . . . , 60 KBs) according to any of the embodiments/variations disclosed above will be helpful since both of the reserved space of the NOR Flash memory and the overall storage volume of a memory device/module implemented with the NOR Flash memory can be optimized. As a result, the related art problems will no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing memory management, the method comprising:
managing a plurality of physical blocks of at least one non-volatile (NV) memory according to a block address translation rule, the block address translation rule of both of one-to-multiple block address translation and multiple-to-one block address translation; and
when it is detected that erasing a specific logical block represented by a specific block logical address is required, determining a set of block physical addresses corresponding to the specific block logical address according to the block address translation rule and erasing a set of physical blocks represented by the set of block physical addresses within the plurality of physical blocks.

2. The method of claim 1, wherein the step of managing the plurality of physical blocks of the at least one NV memory according to the block address translation rule further comprises:
storing/updating at least one look-up table according to the block address translation rule to manage the plurality of physical blocks.

3. The method of claim 2, wherein determining the set of block physical addresses corresponding to the specific block logical address according to the block address translation rule further comprises:
determining the set of block physical addresses according to the at least one look-up table.

4. The method of claim 2, wherein within the at least one look-up table, a number of block physical addresses corresponding to a first block logical address is equal to that of block physical addresses corresponding to a second block logical address.

5. The method of claim 2, wherein within the at least one look-up table, a number of block physical addresses corresponding to each block logical address is equal to a predetermined number.

6. The method of claim 1, wherein a size of the specific logical block is a multiple of that of the set of physical blocks.

7. The method of claim 1, wherein a ratio of a size of each logical block of the NV memory to that of a corresponding set of physical blocks of the NV memory is equal to a predetermined positive integer.

8. The method of claim 1, wherein the at least one NV memory comprises at least one NOR Flash memory.

9. The method of claim 1, wherein the NV memory is utilized for storing program codes to be executed by a portable electronic device; and the method further comprises:
when it is detected that reading a portion of a physical block of the NV memory is required, reading the portion of the physical block byte by byte.

10. The method of claim 9, wherein the NV memory is embedded in the portable electronic device.

11. An apparatus for performing memory management, the apparatus comprising at least one portion of an electronic device, the apparatus comprising:
a processing circuit arranged to control operations of the electronic device, wherein the processing circuit comprises:
a management module arranged to manage a plurality of physical blocks of at least one non-volatile (NV) memory according to a block address translation rule, the block address translation rule of both of one-to-multiple block address translation and multiple-to-one block address translation; and
a control module arranged to control access to the NV memory, wherein when it is detected that erasing a specific logical block represented by a specific block logical address is required, the control module determines a set of block physical addresses corresponding to the specific block logical address according to the block address translation rule and erases a set of physical blocks represented by the set of block physical addresses within the plurality of physical blocks.

12. The apparatus of claim 11, wherein the management module stores/updates at least one look-up table according to the block address translation rule to manage the plurality of physical blocks.

13. The apparatus of claim 12, wherein the control module determines the set of block physical addresses according to the at least one look-up table.

14. The apparatus of claim 12, wherein within the at least one look-up table, a number of block physical addresses corresponding to a first block logical address is equal to that of block physical addresses corresponding to a second block logical address.

15. The apparatus of claim 12, wherein within the at least one look-up table, a number of block physical addresses corresponding to each block logical address is equal to a predetermined number.

16. The apparatus of claim 11, wherein a size of the specific logical block is a multiple of that of the set of physical blocks.

17. The apparatus of claim 11, wherein a ratio of a size of each logical block of the NV memory to that of a corresponding set of physical blocks of the NV memory is equal to a predetermined positive integer.

18. The apparatus of claim 11, wherein the at least one NV memory comprises at least one NOR Flash memory.

19. The apparatus of claim 11, wherein the electronic device is a portable electronic device;
the NV memory is utilized for storing program codes to be executed by the portable electronic device; and when it is detected that reading a portion of a physical block of the NV memory is required, the control module reads the portion of the physical block byte by byte.

20. The apparatus of claim 19, wherein the NV memory is embedded in the portable electronic device.
